(19) United States
(12) Patent Application Publication
(10) Pub. No.: US 2011/0142234 A1
(43) Pub. Date: Jun. 16, 2011

(54) Multi-Factor Authentication Using a Mobile Phone

(76) Inventor: Michael Leonard Rogers, Belmont, CA (US)

(21) Appl. No.: 12/896,914

(22) Filed: Oct. 4, 2010

Related U.S. Application Data
(60) Provisional application No. 61/286,376, filed on Dec. 15, 2009.

(51) Int. Cl. H04K 1/00; H04M 1/66

(52) U.S. Cl. 380/247; 455/411

(57) ABSTRACT

The invention described here provides a fully-distributed solution to the problem of confirming the identity of the presenter of a payment card or other credentials, using multiple factors to authenticate the presenter. The invention leverages the wide penetration of mobile phones in modern economies as the basis for the distributed multi-factor authentication. For additional confidence levels biometric data can be incrementally included as part of the multi-factor authentication. The loss of any one of the multiple authentication factors does not compromise the integrity of the system or the individual, and there is no single point of vulnerability for attack or theft. The invention is fully backwards compatible with current payment cards systems and can be extended to almost any situation where the identity of the presenter of credentials needs to be authenticated prior to allowing the individual access to the protected services, systems, or locations. This allows for incremental adoption across a wide range of current and future systems.

### CROSS REFERENCE TO RELATED APPLICATIONS

This application claims the benefit of provisional patent application No. 61/286,376 with receipt date Dec. 15, 2009 and time stamp 00:19:06

### BACKGROUND

1. Prior Art

The following is a tabulation of some prior art that presently may be relevant:

U.S. Patents

| Pat. No. | Issue Date | Patentee |
|---|---|---|
| 7,707,120 | April 2010 | Dominguez, Manessis et al |

U.S. Patent Application Publications

| Publication Number | Publication Date | Applicant |
|---|---|---|
| 2001/0014158 | Aug-01 | Baltzley |
| 2001/0029496 | Oct-01 | Otto et al. |
| 2001/0039535 | Nov-01 | Tsiounis et al. |
| 2001/0044787 | Nov-01 | Shwartz et al. |
| 2001/0054003 | Dec-01 | Chien et al. |
| 2002/0007352 | Jan-02 | Fieschi et al. |
| 2002/0019811 | Feb-02 | Lapsley et al. |
| 2002/0023059 | Feb-02 | Bari et al. |
| 2002/0069174 | Jun-02 | Fox et al. |
| 2002/0091646 | Jul-02 | Lake et al. |
| 2002/0128977 | Sep-02 | Nambiar et al. |
| 2002/0169720 | Nov-02 | Wilson et al. |
| 2003/0097451 | May-03 | Bjorksten et al. |
| 2003/0120615 | Jun-03 | Kuo |
| 2003/0144952 | Jul-03 | Brown et al. |
| 2003/0200184 | Oct-03 | Dominguez et al. |
| 2003/0208684 | Nov-03 | Camacho et al. |
| 2003/0212642 | Nov-03 | Weller et al. |
| 2004/0044627 | Mar-04 | Russell et al. |
| 2004/0078328 | Apr-04 | Talbert et al. |
| 2004/0083184 | Apr-04 | Tsuei et al. |
| 2004/0177047 | Sep-04 | Graves et al. |
| 2004/0230536 | Nov-04 | Fung et al. |
| 2004/0243520 | Dec-04 | Bishop et al. |
| 2005/0065855 | Mar-05 | Geller |
| 2005/0131826 | Jun-05 | Cook |
| 2005/0192896 | Sep-05 | Hutchison et al. |
| 2006/0269061 | Nov-06 | Balasubramanian et al. |
| 2008/0046362 | Feb-08 | Easterly |
| 2009/0198618 | Aug-09 | Chan et al. |

2. Field

The present invention relates generally to the challenge of authenticating that the presenter of an identification card or other uniquely identifiable credentials such as a login and password is authorized and entitled to use the card or credentials for the intended purpose. More particularly a method is described that provides for secure multi-factor identification and authentication of the presenter of the credentials.

Existing systems primarily utilize some central database of information against which the user and their credentials are quthenticated.

This invention describes a multi-factor authentication solution that makes use of an identification process that is fully distributed onto the personal mobile phone or similar mobile device in the possession of the person presenting the credentials and wishing to be authenticated. Because of the fully distributed design of the solution there is no single point of attack that whereby the system can be compromised.

### BACKGROUND OF THE INVENTION

In modern developed economies and societies there is widespread use of identification cards and credentials that authorize a person to conduct one or more kinds of transaction. Examples abound: credit cards, debit cards, cash cards, food stamp cards, medical cards, entitlement cards, and multiple other uses that are not enumerated here. The same technique described in this invention can also be extended to authenticate a user accessing any system by presenting credentials such as a login id and password to access a system by a user who is otherwise unauthenticated.

Typically in the case of identification cards they contain a unique card identification number plus various devices designed to guard against unauthorized use, including a separate Card Verification Code, a magnetic encoded stripe, an embedded processor chip, a signature stripe, a photograph, and other features intended to deter unauthorized use of the card.

The rate of fraudulent use of cards is widespread causing significant economic loss of goods and services to businesses and consumers due to the difficulty in reliably and readily identifying the user as the authorized user. Cards and identities are frequently stolen and fraudulent duplication of stolen card credentials is relatively easy.

Similarly, users who access systems, such as secure web sites, or email accounts, make use of a login and one or more passwords. Any person who comes into possession of these credentials can also gain access to the target system as there is no authentication performed that the person presenting the credentials is in fact the authorized user.

At the same time there has been an enormous increase in the percentage of persons who own and carry personal mobile devices, such as mobile phones, smart phones, and other similar devices.

The present invention makes use of multiple authentication factors, including possession of a personal mobile device, knowledge of a pass phrase, physical possession of a card, and optionally certain biometric information to determine with a high level of confidence the identity and authority of the person to use the card presented for a given transaction type.

This same technique can also be invoked to authenticate a person presenting credentials used to log into or gain access to a secure system, whereby the credentials take the place of the physical possession of some identification card.

Various different attempts to authenticate the validity of the use of a card or token have met with limited success. Use of PINs (personal identification numbers), or card verification numbers, or showing a government photo identification have all proven of little deterrence to today's sophisticated identify thieves.

Card and token issuers instead rely on various systems to try and determine an unusual pattern of transactions for a particular instrument and block further usage before their losses are too great. These are post facto efforts to contain the losses. The invention described herein is a multi-factor, fully distributed, real time confirmation of the identity of the presenter to use the instrument through positive confirmation of their identity and authority to use the card or token or other credentials presented for access

The present invention is not necessarily limited to authentication of card use, but can be extended to any situations where multi-factor authentication of the person is required prior to permitting an action to be consummated, such as accessing a protected system that requires the presentation of some credentials before access is granted,

Resolving this issue of authentication and authorization will increase security and reduce financial and property loss across many areas of society.

### BACKGROUND—ADVANTAGES

Current systems rely on a very low threshold for authenticating the identity of the presenter of a physical card or other credentials when conducting a transaction or requesting access to a protected system. The use of the signature to authenticate the user is of little practical value as there is little or no validation of the signature of the presenter against the signature recorded on the card. It is a simple matter to create fake cards complete with valid magnetic stripes that can be used by an unauthorized user until the card is denied further transactions by the issuer, which is usually after losses have already been incurred.

Where the credentials of a user have been compromised there is little or no protection against an unauthorized user in possession of the valid credentials from gaining access to the protected system.

Systems that rely upon Card Validation Codes (CVCs) or a personal identification number (PIN) encoded into a chip contained on the card (the so-called smart card) suffer from the problem that the CVC or PIN associated with each card are typically stored in a central data base and associated with the credit card information and other identifying information about the authorized users.

Information about multi-millions of credit cards have been stolen multiple times by successful attacks upon these centralized data bases, leading to further financial losses, and identity theft problems for the users whose information has been compromised.

This particular invention describes an approach to authentication that makes use of multiple factors that are distributed across individual personal mobile devices. There is no central repository of any private information which in turn presents no central point of attack to gain information about masses of card holders or users.

The only centrally held information is a public key associated with each participating user which is used to ensure correct routing and receipt of certain information by the mobile device.

The highly-distributed design of the invention, together with the use of multiple identification factors, including an optional biometric factor, presents an authentication system that is both difficult and expensive to attack and not subject to any centralized method of compromise.

In particular, this multi-factor identity authentication framework can be adopted incrementally without the need for investment in any special equipment, networks, or readers at the point of sale, point of transaction or point of access. The solution described in this invention is fully backwards compatible with all existing credit card, debit card, and other physical credential systems currently deployed in general commerce.

The addition of the biometric data capture, perhaps by use of thumb print reader or similar device, can be incrementally deployed in a fully compatible manner and will serve to add to the confidence level of the authentication of the presenter of the credentials over time.

### BRIEF SUMMARY OF THE INVENTION

It is therefore a principle object of the invention to greatly enhance the authentication of any person who presents a card or similar uniquely identifiable physical token or other credentials, using a combination of their possession of some personal mobile device, the knowledge of a secret pass phrase that is entered into the personal mobile device, and the optional presentation of some unique biometric measurement, such as a finger print, that in combination uniquely associates the person with all of the presented parameters.

To use the invention a person must possess a personal mobile device capable of accepting and downloading an application that runs on the personal mobile device. The vast majority of the hundreds of millions of mobile phones and smart phones shipped in the prior five years provide this feature.

The potential user who wishes to use this invention to protect their authorized use of various cards will first be required to enter a pass phrase into a personal mobile device. The pass phrase is never stored in any non-volatile memory inside the personal mobile device. It is used to dynamically generate a public/private key pair. The generated public key is used to encrypt any non-volatile information within the personal mobile device. The public key is also posted for public access and is associated with the personal mobile device phone number or serial number or other identifying number used to communicate with the personal mobile device,

To secure some kind of card or token with this invention, the user will enter the unique identifying information from the card or token into the personal mobile device, along with their pass phrase. The unique identifying information will be encrypted using the public key dynamically generated from the pass phrase and will be stored in non-volatile memory inside the personal mobile device.

In a similar manner a user may enter information from credentials used to access some protected system or location to which the user requires access. These credentials will be encrypted and stored within the personal mobile device and used for subsequent confirmation of the authenticity of the user when presenting the credentials for accessing such protected systems.

Before any card or other credentials can be authenticated by the mobile phone, the user must first have successfully registered themselves with their mobile phone and also successfully registered with the hone the card of other credentials that are being presented for authentication of some transaction.

To complete the multi-factor authentication initialization the authorized user of the card or other credentials must present themselves, with the physical card or token, activate their personal mobile device using their pass phrase, and optionally present some biometric information to a suitable reader device, typically a finger print reader or similar biometric reader device. The user must also provide the phone number or other contact number for their personal mobile device. Finally when the transaction request is presented to the mobile phone the user is required to positively authorize the transaction before it can proceed.

The optional biometric information along with the unique information from the card or token or credentials presented by the user will be encrypted using the publicly available public key associated with the personal mobile device and transmitted to the personal mobile device by any means available.

The personal mobile device will decrypt the information using the ephemeral private key derived from the secret pass phrase entered by the user and upon successfully decrypting and verifying the information received, will optionally encrypt and retain the biometric data and associate it with the unique identification for the card or token or other credentials presented by the user.

Additional cards or tokens or other credentials may now be associated with the user's biometric information and stored in the personal mobile device in a secure manner.

When the user subsequently wishes to use the invention to conduct a transaction using a previously registered card or token or other credentials, the user presents their card or token or credentials to some second party, and in addition provides the phone or other contact number for their personal mobile device and optionally presents the same biometric measurement, typically a finger or thumb print, to be read by an appropriate reader. The user must also enable their personal mobile device for authentication by entering their secret pass phrase.

The second party retrieves the public key associated with the phone or serial number for the personal mobile device presented by the user. The second party uses this public key to encrypt the details from the card or token presented, together with the biometric information and any other relevant details associated with the transaction and transmits this encrypted information to the device identified by the number provided by the user.

Only the personal mobile device with the valid dynamic private key can decrypt the transmitted information and the information stored inside the personal mobile device. The personal mobile device compares and evaluates the received information in the message against the information stored inside the personal mobile device and returns an encrypted response to the requester indicating the degree to which multiple identifying factors confirm the identification of the presenter. The response message is encrypted using the personal mobile device's ephemeral private key generated from the pass phrase so that only the intended user and personal mobile device can successfully respond, preventing spoofing of the system.

Upon receiving an appropriate response from the personal mobile device the requesting second party receives confirmation of the user's authority to use the card or token with a high level of confidence and security and proceeds to make their decision to cosumate or terminate the current interaction based upon their business rules associated with the degree of confirmation received for the authentication of the user.

Similarly the invention can be used to secure any situation where security is dependent upon the authentication of the presenter of some card or token or other credentials such as a login and password before they are allowed to proceed with the action or transaction or where access is being requested to a secure location or service.

### Glossary of Terms

To assist with the full understanding of the terms used in the description of this invention and the claims made herein, this glossary of terms is provided.
Authentication: The act of determining the identity of a individual and to be assured that they are who they represent themselves to be
Authorization: The act of determining if a duly identified individual has the required permission to conduct the proposed transaction; authorization of a presenter to conduct a transaction is separate and distinct from authentication of the identity of the presenter
Biometric Data: Some physiological measurement that is unique to a particular person; examples are finger print, thumb print, eye iris scan, voice print, hand geometry, face geometry, DNA sequence, all of which are uniquely associated with a single individual
Credentials: Any kind of uniquely identified credential a presenter or user can present as their authority for conducting a transaction or accessing a system; examples include but are not limited to credit cards, debit cards, cash cards, entitlement cards, food stamp cards, medical insurance cards, building access cards, login and password combinations, and security tokens
Decryption: The reverse of encryption; converting obscured data into data that is in the clear
Encryption: Altering data so that it is obscured and it is infeasible in a reasonable period of time to determine the original contents of the data without the possession of a suitable key for reversing the encryption
Ephemeral Data: Data that is never permanently saved anywhere, but existing for a brief moment in time; such as a password or pass phrase that only exists in the volatile memory of a mobile device as it is being keyed in by a user, and is immediately erased after confirmation of its correctness
In the Clear: Information that is not encrypted and if exposed can be copied and used by anybody
Individual: A synonym for a user or a presenter
Level of Confidence: It is not always possible to be 100% certain about something; this is especially true about the identity of an individual when they are not physically present. When the level of identity confidence is high, a second party can accept a higher level of risk when agreeing to enter into a transaction or to grant access to the identified individual
Mobile Device: A portable device capable of voice and data communication over one or more wireless connections, reachable by calling a particular phone number and capable of executing a programmed series of steps and storing certain information in local non-volatile memory
Mobile Phone: A particular kind of mobile device
Non-volatile Memory: Memory such as static RAM, flash memory, hard disk drives, or CD discs that retain information stored on them even when the associated device is powered off.
Pass Phrase: A non-trivial string of alphanumeric characters invented and remembered by a user that allows them to locally authenticate themselves to their mobile device
Personal Mobile Assistant: A particular kind of mobile device
Phone Number: The unique public telephone number used to contact a mobile device using any one of several publicly offered wireless voice and data networks.
Point of Sale: A particular kind of second party found in retail outlets where a presenter conducts purchase transactions
Presenter: The person or user who presents the credentials
Private Key: A digital signature that is uniquely associated with a presenter and is paired with a companion public key such that information encrypted using the private key can only be decrypted using the paired public key
Public Data Base: A data base that is freely available and accessible by any and all parties for reference and retrieval of information; may be replicated, distributed, cached or otherwise accessed as anyone sees fit. It can only be modified by those that have been successfully authenticated and are duly authorized to make updates to the public data base.
Public Key: A digital signature that is uniquely associated with a presenter and is paired with a companion private key such that information encrypted using the public key can only be decrypted using the paired private key; the public key is generally made widely available so that if recipients can successfully decrypt a message using a presenter's public key they are assured that the encrypted message originated from the presenter, who is the only person who possesses the companion private key
Registration: The act of a user identifying themselves to a mobile phone or other system, along with uniquely identifying information such as a secret pass phrase or other unique information, such that the mobile phone or other system can confirm the identity of the returning user when they present the same identifying information they used then they registered.
Second Party: The party with whom the user or presenter wishes to conduct some kind of transaction
Secret Pass Phrase: A pass phrase that the presenter does not share with anyone else and is not stored anywhere in the clear in non-volatile memory
Smart Phone: Any one of several classes of mobile device that function as a mobile phone and provide other enhanced features and facilities
Transaction: Any activity that a presenter and a second party wish to conduct; including purchasing goods or services, allowing access to protected system or resources, allowing access to restricted areas, and other valuable activities that the second party wishes to restrict consumption of or access to
Unattended Point of Sale: Any point of sale that is fully automated, such as a vending machine, that does not have a human attendant
User: Synonym for the presenter of the credentials
Volatile Memory: Memory such as dynamic RAM or other transient memory that does not retain any information when the memory is powered off, nor does any trace remain of any prior contents of volatile memory once the information has been erased

### DRAWINGS

The drawings are an examplar embodiment that illustrates the application of the invention to the authentication of a presenter of an identification card. Similar diagrams can be drawn to illustrate the application of the invention to the authentication of a person presenting some other form of token or other credentials used to access some system or conduct some transaction or activity or gain access to some protected system, service, or location.

In the drawings each individual step in any process is numbered with the form [x.y] where x represents the figure number and y represents a unique suffix number within each figure.

Each drawing has two or more vertical areas designated by a rectangle with a domain title at the top and a reference identifier of the format [x A] where: x is the figure number and A represents a unique alpha identifier. These vertical bounded areas are commonly referred to as swim lanes. Each swim lane, together with its title and identifier, represents the domain in which an activity can take place.

The following lists of domains or swim lanes are to be found in one or more of the figures:

User: Represents a person or presenter of credentials who uses the system to conduct a transaction with a second party

Mobile Device: Represents a personal mobile device such as a mobile phone or smart phone

Point of Sale: Represents a transaction point such as, but not limited to, a supermarket checkout or vending machine or a toll machine or a hospital reception and located at the second party where the User wishes to conduct a transaction

Public Database: Represents any publicly accessible data base that contains the required information.

The symbols that represent activities and decisions are always wholly contained within one of these domains or swim lanes. This indicates the domain in which the activity or decision takes place.

As an example: in FIG. 1 the first domain is title “User” and labeled [1A]. The first activity is “Present Payment Card” and labeled [1.1] indicating that this activity is associate with the User of the system.

FIG. 1 shows the basic authentication flow for a user who presents a card to conduct a transaction. Authentication is performed without the use of biometric information and is used to illustrate the basic authentication flow using a personal mobile device.

FIG. 2 shows the authentication flow where biometric information is presented by the user along with the transaction card. If the biometric information has not previously been captured, it is captured, encrypted, and saved on the personal mobile device if the user otherwise passed the basic authentication requirement, as illustrated in FIG. 1.

FIG. 3 shows how a pass phrase is used to generate public and private keys which are further used to authenticate the user to the personal mobile device. Upon successful registration of the user on the mobile device the generated public key is recorded onto a public data base and associated with the phone number of the personal mobile device.

FIG. 4 shows how a user, who has previously been authenticated to a personal mobile device, registers and stores information about a transaction card that they later wish to use for conducting transactions with a second party using the personal mobile device for authentication and authorization.

FIG. 5 is a legend for the other figures that shows the symbols used and their interpretation.

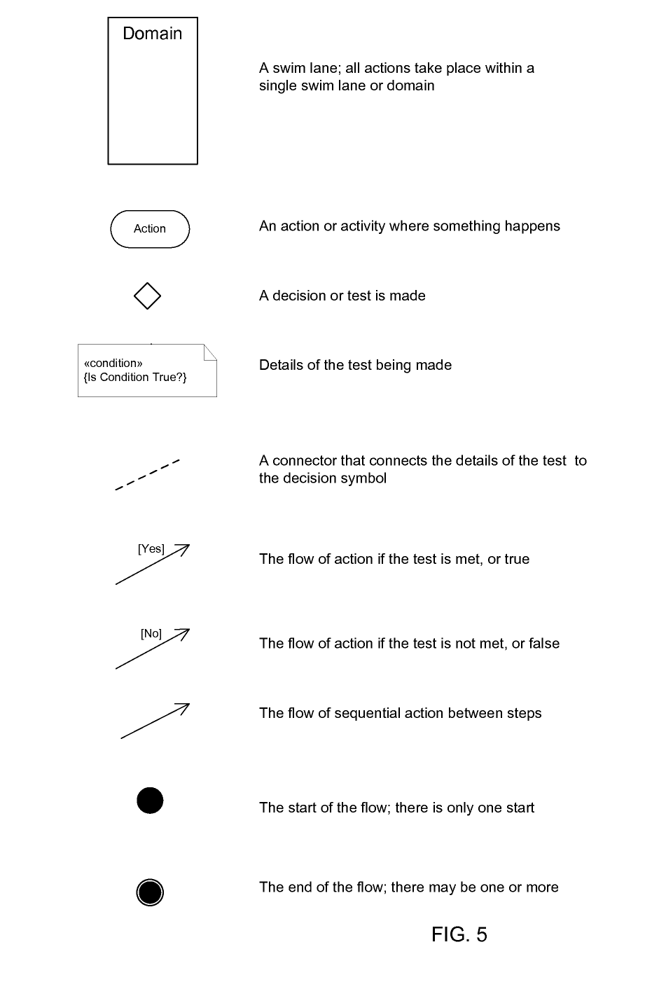

### DETAILED DESCRIPTION

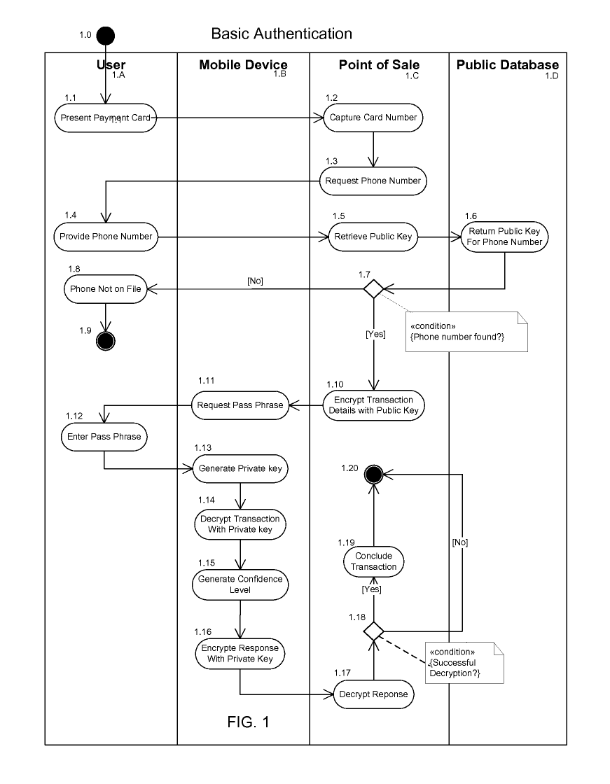

### FIG. 1—First Embodiment

One embodiment of multi-factor authentication is illustrated in FIG. 1. In this first embodiment the User (1A) presents a payment card 1.1, such as a credit card or a debit card that is inscribed with a human readable number or several numbers, at a Point of Sale (1C). The Point of Sale can be a payment station in some store, or at petrol or gasoline station, or an automated vending machine, or any other attended or unattended payment or transaction station.

The Point of Sale captures the card number or numbers 1.2 from the card presented by the User (1A). The Point of Sale then requests the phone number 1.3 from the User who presented the payment card.

The User provides the phone number 1.4 to the Point of Sale for the Mobile Device (1B) that the User has in their possession.

The Point of Sale uses this phone number provided by the User to retrieve the public key 1.5 associated with the phone number provided by the User from a Public Database (1D). The Public Database returns the public key associated with the phone number 1.6 to the Point of Sale if the phone number is found on the Public Database.

The Point of Sale performs a test 1.7 to see if the phone number was found in the Public Database. If the phone number is not located in the Public Database by the Point of Sale, a Phone Not on File message 1.8 is delivered to the User and the transaction is terminated 1.9.

If the phone is found in the Public Database the Point of Sale uses the public key associated with the phone number to encrypt the details of the transaction in progress 1.10 and transmits this encrypted authentication request to the Mobile Device associated with the phone number.

At a minimum this encrypted message must include one or more identifying numbers or letters from the payment card presented by the User. It may contain other information.

Upon receipt of the encrypted authentication request, the Mobile Device requests a pass phrase 1.11 to be entered into the Mobile Device by the User.

The User enters their pass phrase 1.12 into the Mobile Device.

The Mobile Device uses the pass phrase to generate a unique private key 1.13 that corresponds to the public key retrieved by the Point of Sale 1.5 from the Public Database and associated with the phone number 1.6.

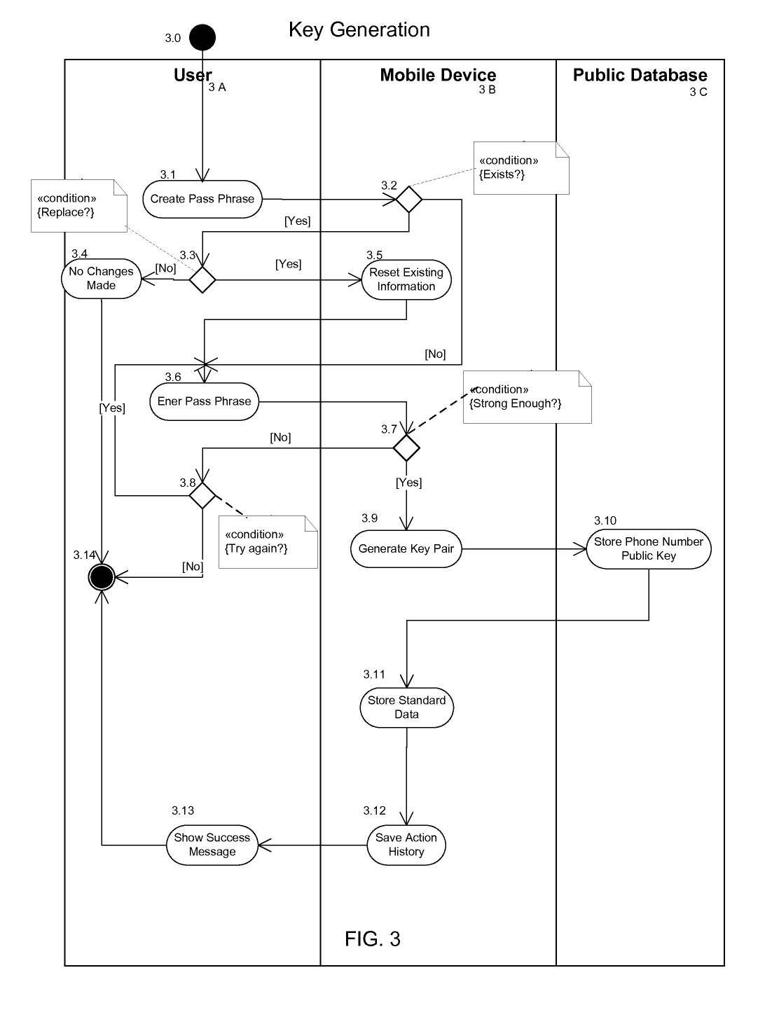

The manner of the generation of the private and public keys and their association with the phone number and their registration in the Public Database are illustrated in FIG. 3 and described elsewhere in this invention description.

The generated private key is used by the Mobile Device to decrypt the contents of the encrypted authentication request containing the transaction details 1.14 received from the Point of Sale.

Using the decrypted transaction details the Mobile Device attempts to authenticate the User and generate a confidence level 1.15.

For successful authentication of the User it is necessary for the following multiple factors to have been successfully accomplished:
i. The Mobile Device must be able to successfully decrypt the message using the private key derived from the pass phrase entered by the user
ii. The card information contained in the encrypted transaction message must match encrypted card information saved on the Mobile Device.
iii. The User must be in possession of the Mobile Device that is addressable by the phone number and be capable of entering the pass phrase that is used by the Mobile Device to generate the private key
iv. The card information must have previously been successfully registered on the

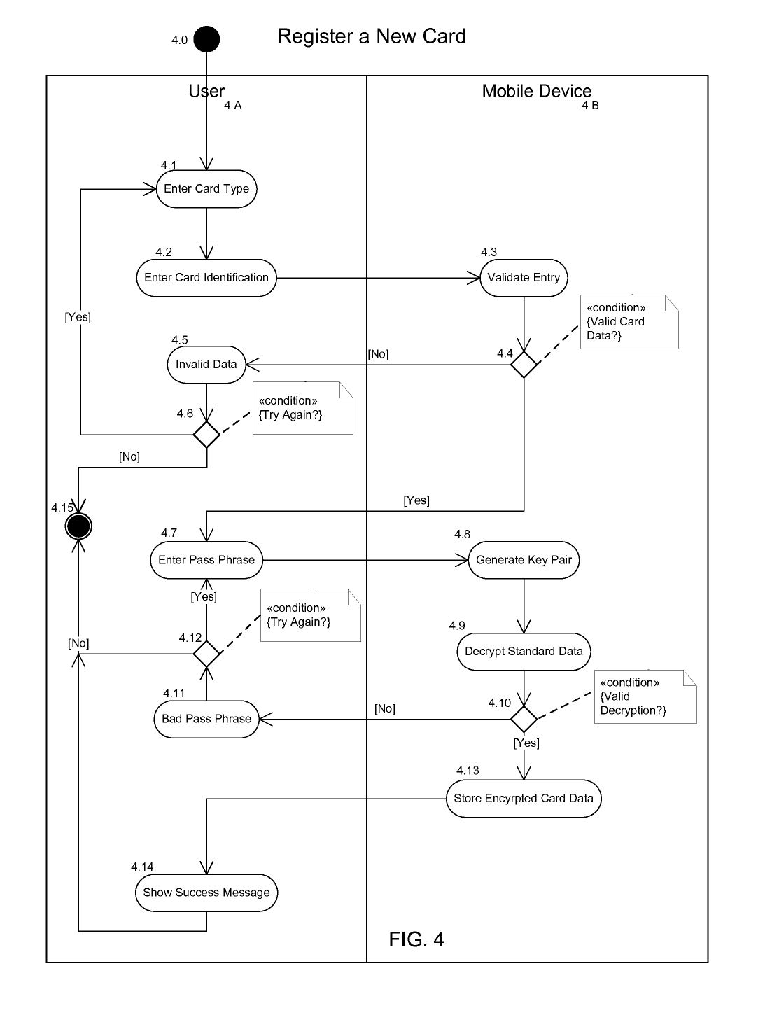

Mobile Device by the user registered on the device. This process of card registration is illustrated in FIG. 4 and described elsewhere in this invention.

The confidence level, in this embodiment, may range from zero, meaning there is no confidence in the authenticity of the User, up to a maximum of 100, meaning that there is the highest level of confidence that the User is authenticated by the Mobile Device with the transaction information presented in the authentication request by the Point of Sale at 1.10.
The confidence level as determined by the Mobile Device is encrypted with the private key generated by the Mobile Device at 1.13 and this encrypted authentication response is returned to the Point of Sale 1.16
The Point of Sale will decrypt the authentication response received from the Mobile Device 1.17 using the public key that the Point of Sale previously retrieved from the Public Database in 1.5.
The Point of Sale will test for successful decryption of the message 1.18. This step of testing the decryption using the public key of the Mobile Device to which the encrypted request was sent in 1.10 prevents an intruder from masquerading as the authentic Mobile Device and sending a bogus response to the Point of Sale.
Where the decryption by the Point of Sale is successful the Point of Sale will conclude the transaction 1.19 using the confidence level returned from the Mobile Device and complete the transaction 1.20.
In the case where decryption of the response from Mobile Device by the Point of Sale is not successful the Point of Sale should take appropriate action and terminate the transaction 1.20.

Upon conclusion of the process by the Mobile Device and the sending of the encrypted authentication response to the Point of Sale in 1.16, all generated public and private keys within the Mobile Device are erased from memory. Generated keys are never retained by the Mobile Device.

### DETAILED DESCRIPTION

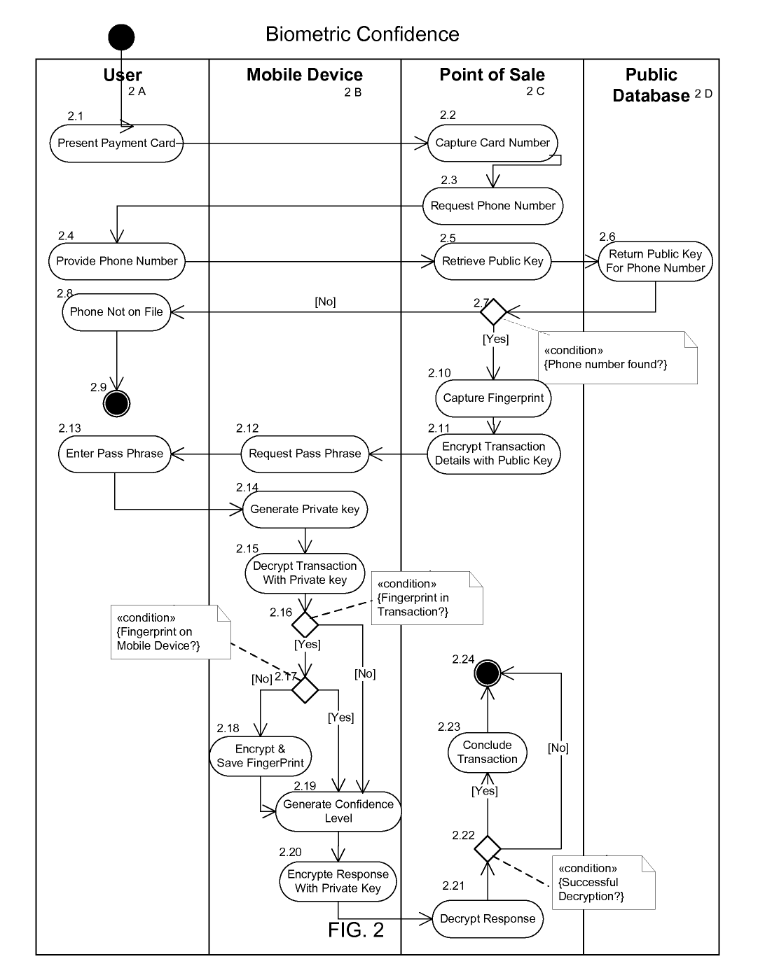

### FIG. 2—Second Embodiment

A second embodiment of multi-factor authentication is illustrated in FIG. 2. In this embodiment we cover the capture of the biometric data from the User 2A and the generation of a confidence level of authentication for the User by including the use of biometric data associated with the User

In this second embodiment the User presents a payment card 2.1, such as a credit card or a debit card that is inscribed with a human readable number or several numbers, at a Point of Sale (2C). The Point of Sale can be a payment station in some store, or at petrol or gasoline station, or an automated vending machine, or any other attended or unattended payment or transaction station.

The Point of Sale captures the card number or numbers 2.2 from the card presented by the User. The Point of Sale then requests the phone number 2.3 from the User who presented the payment card.

The User provides the phone number 2.4 to the Point of Sale for the Mobile Device (2B) that the User has in their possession.

The Point of Sale uses the phone number provided by the User to retrieve the public key 2.5 associated with the phone number from a Public Database (2D). The Public Database returns the public key associated with the phone number 2.6 to the Point of Sale if the phone number is found on the Public Database.

The Point of Sale performs a test 2.7 to see if the phone number was found in the Public Database. If the phone number is not located on Public Database by Point of Sale, a Phone Not on File message 2.8 is delivered to the User and the transaction is terminated 2.9.

If the phone number is found in the Public Database the Point of Sale then captures a biometric factor from the User, In this embodiment a finger print is captured 2.10 but it can be any unique biometric factor associated with the User. The Point of Sale uses the public key associated with the phone number to encrypt the details of the transaction in progress 2.11. The encrypted authentication request message may also include other information as required for the particular kind of transaction.

At a minimum this encrypted message must include one or more identifying numbers or letters from the payment card presented by the User in 2.2 and the biometric data from the User, in this embodiment a finger print, as captured in 2.10. It may contain other information. The encrypted authentication request message is transmitted to the Mobile Device associated with the phone number provided earlier by the User in 2.4.

Upon receipt of the encrypted transaction message, the Mobile Device requests a pass phrase 2.12 to be entered into the Mobile Device by the User.

The User enters their pass phrase 2.13 into the Mobile Device.

The Mobile Device uses the pass phrase to generate a unique private key 2.14 that corresponds to the public key retrieved by the Point of Sale 2.5 from the Public Database.

The manner of the generation of the private and public keys and their association with the phone number and their registration in the Public Database are illustrated in FIG. 4 and described elsewhere in this invention description.

The generated private key is used by the Mobile Device to decrypt the contents of the encrypted authentication request message 2.15.

A test is made 2.16 by the Mobile Device to determine if there is biometric data, in this embodiment finger print information, included within the encrypted message.

Where there is no biometric data included in the authentication request message the Mobile Device proceeds directly to generate the confidence level 2.19. In the case of missing biometric data, the second embodiment becomes equivalent to the first embodiment and there is exact equivalence in the functionality from 1.15. and 2.19 going forwards in the first and second embodiments respectively.

When there is biometric data included in the authentication request message, the Mobile Device performs a test 2.17 to determine if prior encrypted biometric data is already stored on the Mobile Device.

If there is a previously stored biometric data on the Mobile Device, in this embodiment finger print data, it is decrypted 2.18 using the private key generated from the pass phrase in 2.14.

In this embodiment, the newly presented finger print data from 2.17 and any finger print data retrieved from the Mobile Device storage 2.18 is now used, along with the decrypted transaction authentication request message information to generate a confidence level 2.19 for the User. The confidence level, in this embodiment, may range from zero, meaning there is no confidence in the authenticity of the User, up to a maximum of 100, meaning that there is the highest level of confidence that the User is authenticated by the Mobile Device with the transaction card information presented by the Point of Sale at 2.11.

Using the decrypted transaction authentication request message the Mobile Device generates a confidence level for the User 2.19.

The following multiple factors are used to compute the confidence level for the User:
i. The Mobile Device must be able to successfully decrypt the authentication request message using the private key derived from the pass phrase
ii. The card information contained in the encrypted transaction message must match encrypted card information saved on the Mobile Device
iii. The User must be in possession of the Mobile Device that is addressable by the phone number and be capable of entering the pass phrase that is used by the Mobile Device to generate the public and private keys
iv. The card information must have previously been successfully registered on the Mobile Device. This process of card registration is illustrated in FIG. 4 and described elsewhere in this invention
v. The User biometric information, in this embodiment a finger print. The finger print may previously have been captured, encrypted, and saved on the Mobile Device or this may be the first time a finger print has been presented, in which case the finger print will be captured, encrypted using the public key generated within the Mobile Device, and saved on the Mobile Device.
The confidence level as determined by the Mobile Device is encrypted with the private key generated by the Mobile Device at 2.13 and this encrypted authentication response is returned to the Point of Sale 2.20
The Point of Sale will decrypt the authentication response received from the Mobile Device 2.21 using the public key that the Point of Sale previously retrieved from the Public Database in 2.5.
The Point of Sale will test for successful decryption of the authentication response message 2.22. This step of testing the decryption using the public key of the Mobile Device to which the encrypted request was sent in 2.11 prevents an intruder from masquerading as the authentic Mobile Device and sending a bogus response to the Point of Sale.
Where the decryption by the Point of Sale is successful the Point of Sale will conclude the transaction 2.23 using the confidence level returned from the Mobile Device and complete the transaction 2.24.
In the case where decryption of the response from Mobile Device by the Point of Sale is not successful the Point of Sale should take appropriate action and terminate the transaction 2.24.

Upon conclusion of the process by the Mobile Device and the sending of the encrypted response to the Point of Sale in 2.20, all generated public and private keys within the Mobile Device are erased from memory. Generated keys are never retained by the Mobile Device.

### DETAILED DESCRIPTION

### FIG. 3—Key Generation

The various embodiments of this patent require the use of a strong encryption mechanism which requires the generation and protection of strong keys that cannot be readily compromised, revealed or reverse engineered.

This preferred key generation embodiment describes a process used to generate, use, and protect the keys for any and all of the embodiments of the multi-factor authentication. Other possible embodiments that can reliably generate a public private key pair from user-provided input are also possible but are not described here.

In FIG. 3, the User (3A) initiates the process, 3.0, to create a pass phrase 3.1 and this is entered into the Mobile Device (3B).

A test is made 3.2 to determine if a pass phrase has previously been created.

If a pass phrase has previously been created, the User is asked, 3.3, if they wish to replace the previously generated phrase.

If the User declines, no change is made, 3.4, and the process is terminated 3.14.

If the User accepts the offer to replace the previously generated phrase, then all previously stored information on the Mobile Device is erased and reset 3.5.

This erases all information about the User, any transaction card information, any biometric data, and any other user information associated with the Mobile Device. This seemingly drastic step is done to be certain that if a Mobile Device is lost or stolen or compromised, no unauthorized user can change the pass phrase and make use of any information previously stored on the Mobile Device.

In the case where no previous pass phrase has been entered, or the User elects to replace the previous pass phrase, the User enters a pass phrase 3.6 into the Mobile Device.

The Mobile Device will test the pass phrase 3.7 to ascertain that it passes certain tests, this to ensure that the pass phrase is non-trivial and can resist certain dictionary and other forms of attack. If the pass phrase is not strong enough, the User is asked if they wish to try again 3.8.

If the User accepts the invitation to retry, they are taken back to 3.6 to enter a pass phrase. If the User declines to retry, the process is terminated, 3.14, and the Mobile Device will then contain no stored information and the Mobile Device will not be validly registered on the Public Database (3C).

Where the pass phrase passes is ascertained to be strong enough to resist attacks, it is used by the Mobile Device, along with other internal Mobile Device information to create a public/private key pair 3.9 that is uniquely associated with the pass phrase and the particular Mobile Device being used to generate the public private key pair.

The public key is transmitted to some Public Database (3C) where it will be stored and associated with the phone number associated with the Mobile Device. The Public Database can be any publicly accessible data base that can store the public key and index it by the Mobile Device phone number for later retrieval. As this is the public key for the Mobile Device it can be widely and freely replicated and made available across any number of other public databases without restriction.

Following the successful storing of the phone number and public key 3.10 on some Public Database, the public key will be used to encrypt and store some standard data 3.11 on the Mobile Phone in some non-volatile memory location.

The generated public and private keys are then discarded. The generated keys and the pass phrase are never recorded in any permanent manner within the Mobile Device; they are always ephemeral and retained in volatile memory long enough to complete the current task. The private key is ephemeral and is always generated afresh as part of the generate key pair function (1.13, 2.14, 3.9, and 4.8), upon each use of the Mobile Device thus preventing anyone who steals the Mobile Device from reverse engineering the private key or pass phrase.

In one embodiment of this feature the Mobile Device takes the public key generated from the pass phrase in 3.9 and uses this public key to encrypt and store the pass phrase entered by the User (3.11). Whenever the User attempts to use the Mobile Device multi-factor authentication functions, the Mobile Device must be able to take the ephemeral private key generated from the pass phrase, and successfully decrypt and match the pass phrase that was previously encrypted and saved on the Mobile Device using the public key.

In other embodiments different or additional static, unchanging, information can be used and encrypted with or without the pass phrase using the public key. The only requirement is that upon decryption of the encrypted stored standard data using the generated private key, the Mobile Device can validate the decrypted information.

If the Mobile Device cannot successfully decrypt the previously encrypted and stored standard data using the ephemeral private key, then the entered pass phrase is not valid and appropriate action is taken.

All actions surrounding key generation and pass phrase creation are saved in an action history log 3.12.

Upon successful completion of the pass phrase entry and public/private key pair generation and storage of the encrypted standard data a success message 3.14 is presented to the User and the process is concluded 3.14.

Upon conclusion of the process, 3.14, all generated public and private keys within the Mobile Device are erased from memory. The pass phrase and any generated keys are never retained by the Mobile Device.

### DETAILED DESCRIPTION

### FIG. 4—Card Registration

The various embodiments of this invention require that any transaction card or other identifying token or credential to be used by the User (4A) first be registered with the Mobile Device (4B) prior to use. In this embodiment it is assumed that we are using a transaction card, such as a credit card or a debit card or a cash card or an entitlement card with uniquely identifying imprinted numeric or alphanumeric information. Other embodiments can make use of any token or other credentials possessed by the User that have unique identifying information imprinted upon it that can be read by the User and entered into the Mobile Device.

The User initiates card registration 4.0 and enters the card type 4.1. The User then enters identifying information for the card 4.2.

The Mobile Device validates the card information entered, 4.3, based on the card type entered in 4.1. A test is made to determine if the card information is valid for the card type 4.4.

If the card information is not valid for the card type an invalid data message 4.5 is displayed to the User.

The User decides whether to try again 4.6 to enter card type and card information. If the User decides to try again control returns to 4.1, enter card type. If the User decides not to try again, the card registration process is concluded 4.15.

If the card information is valid, 4.4, the User is invited to enter a pass phrase 4.7.

The pass phrase, perhaps in combination with other static information internal to the Mobile Device and as described in detail elsewhere in this invention, is used to generate a public/private key pair 4.8.

The private key, generated in 4.8, is used to decrypt the standard data 4.9 previously encrypted with the public key and stored within the Mobile Device at 3.11 when the User originally created the public/private key pair from the pass phrase during the User registration process, as detailed in FIG. 3.

The Mobile Device tests, 4.10, to determine if the decryption of the standard data using the generated private key was successful. If the decryption fails a bad pass phrase message 4.11 is displayed to the User.

The User is asked if they wish to try again 4.12. If User elects to try again, User is returned to 4.7 to enter pass phrase. If User declines to try again, process is concluded 4.15.

If decryption of standard data by the Mobile Device is successful, the User has entered the valid pass phrase. The identifying information entered for the card is encrypted with the generated private key and stored within the Mobile Device in non-volatile memory 4.10.

User is shown a success message 4.14 to indicate the successful registration of the card's information and the process is concluded 4.15.

Upon conclusion of the process, 4.15, all generated public and private keys within the Mobile Device are erased from memory. Generated keys are never retained by the Mobile Device.

### Additional Embodiments with Additional Encryption and Data

There is no separate figure for this embodiment.

In the embodiment described in FIG. 1 the authentication request message created by the Point of Sale includes at a minimum sufficient information to identify the Payment Card presented by the User at the Point of Sale. The authentication request is encrypted using the public key associated with the Mobile Device and retrieved from the Public Database which ensures that only the Mobile Device that possesses the matching private key can decrypt the authentication request.

The receiving Mobile Device has no assurance of the source of the encrypted authentication request as the public key used to encrypt the authentication request is publicly available from the Public Database.

To provide further security and risk reduction the following additions can be made to the embodiment in FIG. 1.

When the Point of Sale creates the transaction authentication request message 1.10 the Point of Sale includes the following additional information in the authentication request:
i. A unique transaction identification number is generated and included as part of the authentication request by the Point of Sale and is encrypted using the private key associated with the particular Point of Sale
ii. The public key for the Point of Sale is included in the authentication request such that it will be retrievable by the Mobile Device when the authentication request is successfully decrypted by the Mobile Device 1.14
When the Mobile Device decrypts the authentication request 1.14 it gains access to the Point of Sale public key in included in the authentication request details. The Mobile Device uses this Point of Sale public key to decrypt the transaction identification included in the authentication request by the Point of Sale.
When the Mobile Device creates the authentication response 1.16 it includes the transaction identification which is encrypted using the Point of Sale public key, prior to encrypting the whole of the authentication response using the Mobile Device generated private key.
When the Point of Sale decrypts the authentication response 1.17 it further decrypts the encrypted transaction identification using the Point of Sale private key providing further assurance that the authentication response received was created by the Mobile Device to whom the authentication request was sent.

This same additional data and encryption can also be incorporated into the embodiment illustrated by FIG. 4 where biometric data is included in the authentication request sent to the Mobile Device by the Point of Sale.

### DETAILED DESCRIPTION

### Public Private Keys

There is no separate diagram for this discussion. The pass phrase selected by the user is used as input to the public private key generation algorithm referenced in various the FIGS. (1.13, 2.14, 3.9, 4.8). In addition, for further security and enhancement, other reliable inputs might be used such as the phone number associated with the mobile device or the serial number associated with the mobile device or the identification number assigned to a SIM used with the mobile device.

The requirement for the public private key generation algorithm used in this invention is that when the same input is provided to the key generation algorithm the same public private key pair is returned.

The pass phrase is known only to the authorized user; the phone number associated with the mobile device might be transferred from one mobile device to another. The serial number associated with a mobile device is typically non-volatile and uniquely assigned by the manufacturer of the mobile device. The identification number of a SIM is typically unique and assigned by the manufacturer of the SIM.

Given the user does not divulge their pass phrase to anyone there is a vanishingly small chance that the same public private key pair can be created by an attacker, even where the attacker has access to the phone number and device serial number and SIM identification number associated with the user.

The public private key pair is always generated on demand and in response to the user entry of the pass phrase on the mobile device where the key pair was originally created at key registration time.

### SUMMARY OF ADVANTAGES

From the description of the first embodiments above, it is evident that the use of multi-factor authentication using a personal mobile device can provide positive identification of the user by virtue of:
i) The user presenting the information from some card or some credentials in their possession
ii) The user presenting the card has possession of the mobile device for which the public key associated with the phone number of said mobile device allows decryption of the authorization request message sent to said phone number
iii) The user presenting the card has knowledge of the pass phrase required to enable successful decryption of the authorization request message sent to said phone number
iv) The card presented by the user has previously been successfully registered, encrypted, and stored on said mobile device

This multi-factor authentication can be invoked even when the user presenting the card is not present at a point of sale, for example, when making a purchase using an on-line internet based web site.

From the description of the second embodiment above, the additional advantage provided for multi-factor authentication is the requirement that the user presenting some card also provides biometric data, in the said embodiment a finger print, which adds a further degree of authentication that the user is authorized to use the card.

Prior attempts have suffered from not addressing the fundamental issue of reliably confirming the identity of the presenter of a payment card or other credentials nor have they leverage personal mobile devices. Additionally many prior solutions have relied upon a central repository of authentication information, such as the use of the card security code or associated pin number, which provides a central point of attack or compromise of the authentication information for a large number of cards or other credentials.

Other solutions have required the installation of additional devices such as special chip readers for cards with embedded micro-chips, requiring the agreement on a single standard and a large investment, while still not addressing the fundamental problem of authenticating the presenter of the card or other credentials.

The newest technology, called Near Field Communications, or NFC, does nothing to enhance the authentication of the presenter; it merely replaces the plastic card with a chip attached to or built into a mobile phone device that can be read by a suitably placed NFC reader. It essentially replaces the plastic payment card with a newer technology micro-radio-chip that can be passed over a suitable reader that has been installed at the point of transaction.

The current invention described herein is the first that provides a fully distributed solution that is fully backward compatible with existing deployed payment card infrastructure. It is thus not subject to any centralized attack or compromise, and can be adopted in an incremental manner. The addition of biometric data for enhanced authentication can likewise be added incrementally following deployment of the initial distributed authentication solution. Biometric readers can be selectively added to those locations where the value of the transactions or the existing level of fraud merits the investment.

### Resistance to Compromise of Theft

The embodiments described in this invention for multi-factor authentication are highly resistant to compromise, theft, or loss of one or more of the components.

For all embodiments a successful attack would require the theft of the pass phrase known only to the user, plus the information associated with a card registered on the mobile device, plus the mobile device with the card registration information or the substitution of a replica of said mobile device that can answer the same phone number and dynamically generate the same private key from said pass phrase. In the embodiment where the finger print is used it would also be necessary to create a credible replica of the finger print used to authenticate the authorized user with the mobile device.

For all embodiments all critical authentication factors are fully distributed across the population of users, mobile devices, and payment cards. The only central repository of information is the public keys associated with their respective mobile device phone numbers. Public keys are by definition public and not subject to being compromised.

Where a hacker or malevolent employee or some other person reveals the contents of some centralized database of card information, there will not be sufficient available to compromise the multi-factor authentication system as all information other than public keys and mobile device phone numbers is fully distributed.

Any person or system attempting to penetrate the system would have to expend a similar level of effort to locate and penetrate the mobile device and personal information for each single individual person and each single individual card, making such an attack uneconomic.

If the user loses control of their mobile device there is no information recorded on the mobile device that would enable any systemic attack to be made against the mobile device; the private key is ephemeral and never stored by the mobile device. Where the finger print is also encrypted and stored on the mobile device this presents a practically insurmountable barrier to successful imposters.

### Conclusion, Ramifications, and Scope

The adoption of multi-factor authentication using a mobile device as described in these embodiments leads to greatly enhanced authentication of the user presenting some card, token, or other credentials for conducting a transaction or gaining access to some protected system, resource, or location.

If the mobile device or the card is lost or compromised the person now in possession of the card, the card number, or the mobile device is unable to authenticate to the mobile device and any attempted transactions will be denied.

The obvious ramifications are a tremendous reduction in the losses associated with the unauthorized use of cards for making transactions. These losses currently amount to tens of billions of dollars annually. Wide adoption of the multi-factor authentication will yield improved profits for those that support multi-factor authentication for card-based transactions and will ultimately benefit the consumers who pay for the losses through increased card fees, interest rates, and the transaction fees incurred by merchants who accept card-based payments for transactions.

Mobile device vendors and associated mobile device network vendors will gain through an increase in message traffic making use of their respective networks and devices

Multi-factor authentication is extensible to support almost any form of transaction or system access where an identifying token or other credentials are presented by the user. This might include, but is not limited to credit and debit card payments, as well as entitlement identification cards such as food stamps, social services entitlement, medical services, and any other situation where reliable authentication of the holder of the card or presenter of the credentials is desirable before allowing access to or delivering the service or permitting access to a protected system, resource, or location.

Additionally the multi-factor identification can be extended to automated service delivery points, such as vending machines, on-line purchases, and other automated delivery points, where the user is required to present a card or other credentials to consummate the transaction. In the case of automated service delivery points the addition of a finger print reader would provide a high enough degree of user authentication that transactions of any value could now be conducted with a very low risk of unauthenticated use.

The scope for the multi-factor authentication can thus be seen to greatly reduce the risk of unauthorized for a broad scope of economic and entitlement based transactions where the user presents an identifying card with which to conduct the transaction.

I claim:

1. A method by which a presenter of a uniquely identifiable credential is authenticated for conducting a transaction with a second party comprising:
a. a mobile phone whereon said presenter has previously been registered and associated with a secret pass phrase known only to said presenter
b. a public key generated when said presenter registered themselves on said mobile phone using said secret pass phrase
c. a private key generated when said presenter registered themselves on said mobile phone using said secret pass phrase
d. a public data base wherein the phone number associated with said mobile phone is registered and associated with said generated public key that is transmitted to and saved in said public data base when said presenter registered themselves with said mobile phone
e. the registration of said uniquely identifiable credential on said mobile phone whereon said presenter has previously been registered
f. when said uniquely identifiable credential is presented to said second party by said presenter as authority to conduct said transaction, said second party uses said phone number of said mobile phone provided by said presenter of said uniquely identifiable credential to retrieve said public key from said public data base
g. said second party transmits to said mobile phone an authentication request encrypted using said public key retrieved from said public data base
h. said mobile phone on receipt of said encrypted authentication request uses said generated private key, associated with said presenter and said secret pass phrase entered into said mobile phone by said presenter, to decrypt said authentication request received by said mobile phone from said second party
i. said mobile phone uses said decrypted contents of said authentication request to determine authenticity of said presenter of said uniquely identifiable credential included in said authentication request
j. said user is requested to authorize said transaction request presented by said second party using said mobile phone
k. said mobile phone, if said presenter successfully authorizes said transaction request, generates and returns to said second party an authentication response encrypted using said generated private key associated with said presenter previously registered on said mobile phone
l. said second party decrypts said authentication response using said public key retrieved from said public data base and determines whether to accept or deny said transaction,

2. A method as recited in claim 1 where said authentication request from said second party is transmitted to said mobile phone unencrypted.

3. A method as recited in claim 2 where said authentication response from said mobile phone is transmitted to said second party unencrypted.

4. A method as recited in claim 1 where said authentication response contains a degree of confidence for the authenticity of said presenter of said uniquely identifiable credential.

5. A method as recited in claim 1 where said second party includes within said encrypted authentication request a copy of a unique public key associated with said second party and a unique identifier for said transaction comprising:
a. inclusion of said unique identifier of said transaction provided by said second party in said authentication response returned to said second party from said mobile phone
b. encryption of all or part of said authentication response from said mobile phone using said public key associated with said second party and provided in said authentication request
c. decryption of said encrypted authentication response by said second party using private key associated with said second party and associated with said public key associated with said second party and transmitted in said authentication request
d. validation by said second party of said unique transaction identifier returned by said mobile phone and contained in said encrypted authentication response.

6. A method as recited in claim 5 where said authentication request from said second party is transmitted to said mobile phone unencrypted.

7. A method as recited in claim 6 where said authentication response from said mobile phone is transmitted to said second party unencrypted.

8. A method as recited in claim 5 where said authentication response contains a degree of confidence for the authenticity of said presenter of said uniquely identifiable credential.

9. A method by which a presenter of a uniquely identifiable credential is authenticated for conducting a transaction with a second party comprising:
a. a mobile phone whereon said presenter has previously been registered and associated with a secret pass phrase known only to said presenter
b. a public key generated when said presenter registered themselves on said mobile phone using said secret pass phrase
c. a private key generated when said presenter registered themselves on said mobile phone using said secret pass phrase
d. a public data base wherein phone number associated with said mobile phone is registered and associated with said generated public key that is transmitted to and saved in said public data base when said presenter registered themselves with said mobile phone
e. the registration of said uniquely identifiable credential on said mobile phone whereon said presenter has previously been registered
f. when said uniquely identifiable credential is presented to said second party by said presenter as authority to conduct said transaction, said second party uses said phone number of said mobile phone provided by said presenter of said uniquely identifiable credential to retrieve said public key from said public data base
g. said second party retrieves from said presenter of said uniquely identifiable credential uniquely associated biometric data comprising:
i. a thumb print, or finger print, or eye iris pattern scan, or voice print, or DNA pattern, or DNA signature, or hand geometry, or face scan or other biometric data uniquely associated with said presenter
h. said second party transmits to said mobile phone an authentication request that includes said biometric data, in addition to any other information, encrypted using said public key retrieved from said public data base
i. said mobile phone on receipt of said encrypted authentication request uses said generated private key, associated with said presenter and said secret pass phrase entered into said mobile phone by said presenter, to decrypt said authentication request received by said mobile phone from said second party
j. said user is requested to authorize said transaction request presented by said second party using said mobile phone
k. said mobile phone, if said presenter successfully authorizes said transaction request, uses decrypted contents of said authentication request and said biometric data included in said authentication request with said encrypted biometric data previously stored on said mobile phone, if any, to determine authenticity of said presenter
l. said mobile phone generates and returns to said second party an authentication response encrypted using said generated private key associated with said presenter previously registered on said mobile phone
m. said second party decrypts said authentication response using said public key retrieved from said public data base and determines whether to accept or deny said transaction,

10. A method as recited in claim 9 where said authentication request from said second party is transmitted to said mobile phone unencrypted.

11. A method as recited in claim 10 where said authentication response from said mobile phone is transmitted to said second party unencrypted.

12. A method as recited in claim 9 where said authentication response contains a degree a confidence of the authenticity of said presenter of said uniquely identifiable credential.

13. A method as recited in claim 9 wherein, when said mobile phone receives said authentication request containing said biometric data for the first time, said mobile phone retains said biometric data from said presenter included in said authentication request transmitted by said second party and said biometric data is encrypted and store on said mobile phone using said public key associated with said presenter previously registered on said mobile phone.

14. A method as recited in claim 9 where said second party includes within said encrypted authentication request a copy of a unique public key associated with said second party and a unique identifier for said transaction comprising:
a. inclusion of said unique identifier of said transaction provided by said second party in said authentication response returned to said second party from said mobile phone
b. encryption of all or part of said authentication response from said mobile phone using said public key associated with said second party and provided in said authentication request
c. decryption of said encrypted authentication response by said second party using private key associated with said second party and associated with said public key associated with said second party and transmitted in said authentication request
d. validation by said second party of said unique transaction identifier returned by said mobile phone and contained in said encrypted authentication response.

15. A method as recited in claim 14 where said authentication request from said second party is transmitted to said mobile phone unencrypted.

16. A method as recited in claim 15 where said authentication response from said mobile phone is transmitted to said second party unencrypted.

17. A method as recited in claim 14 where said authentication response contains a degree a confidence of the authenticity of said presenter of said uniquely identifiable credential.
whereby confirmation of the identity of said presenter is distributed onto each said mobile phone on which said presenter and said uniquely identifiable credential have previously been registered, providing a fully distributed mobile multi-factor identity authentication solution.
